(19) United States
(12) Patent Application Publication
(10) Pub. No.: US 2025/0007171 A1
(43) Pub. Date: Jan. 2, 2025

(54) SINGLE-SUBSTRATE OMNIDIRECTIONAL DIELECTRIC RESONATOR ANTENNA WITH ORTHOGONAL DRA MODES

(71) Applicant: City University of Hong Kong, Kowloon (HK)

(72) Inventors: Kwok Wa Leung, Kowloon (HK); Peng Fei Hu, Kowloon (HK)

(21) Appl. No.: 18/641,786

(22) Filed: Apr. 22, 2024

Related U.S. Application Data
(60) Provisional application No. 63/510,954, filed on Jun. 29, 2023.

(51) Int. Cl. H01Q 9/04; H01Q 1/22

(52) U.S. Cl. CPC H01Q 9/0485; H01Q 1/22

(57) ABSTRACT

A dielectric resonator antenna, which includes a dielectric resonator and a substrate on which a planar feeding circuit is configured. The dielectric resonator is located on a first side of the substrate. The planar feeding circuit contains a first feeding part and a second feeding part. The first and second feeding parts are adapted to excite two orthogonal DRA modes in a same frequency band. Due to its polarization diversity, the antenna can be used to replace two commercial Wi-Fi antennas. It can simultaneously be used as a projection device for decoration and advertising.

### FIELD OF INVENTION

This invention relates to radiofrequency (RF) devices, and in particular to dielectric resonator antennas (DRAs).

### BACKGROUND OF INVENTION

Wi-Fi technology is widely used in wireless communications [1], [2]. The global consumer Wi-Fi router market is huge, with a value of US$6.701 billion in 2019. It has been anticipated to reach US$9.341 billion in 2026 [3]. For Wi-Fi routers, the antenna part is of paramount importance because it affects signal transmission and reception directly [4]-[9]. Antennas can be traced back to Heinrich Rudolph Hertz, who demonstrated the first wireless electromagnetic system in 1886. He used an end-loaded half-wave dipole and a square loop antenna as the transmitting and receiving antennas, respectively [10]. Guglielmo Marconi invented the monopole antenna, which can send a signal over a long distance in 1901 [11], [12]. Since then, many new antenna elements have been introduced. For example, Yagi-Uda antennas were proposed in 1925 [13]. Later, microstrip antennas were developed in 1973 [14]. In 1983, the dielectric resonator antenna was proposed [15], which has a number of advantages such as its small size and high efficiency.

Optically transparent antennas are emerging due to the increasing need of invisible and esthetic antennas. In general, there are two approaches to obtain a transparent antenna. In the first approach, a transparent conductive film for the radiator part is used. It is placed on a transparent PCB substrate made of glass or polymethylmethacrylate. The transparent conductive film can be made of transparent conductive oxide (TCO) like the indium tin oxide (ITO) and fluorine-doped tin oxide (FTO) [16]-[18]. It can also be made of nanocarbon [19], silver-coated polyester (AgHT) film [20], or conductive polymer [21]. Recently, metallic nanostructures have been developed to obtain the transparent conductive film [22]-[24]. In general, using a transparent conductive film to design a transparent antenna suffers from significant power loss due to the skin effect and high surface resistance of the conductive film. The higher the optical transparency is required, the thinner the conductive film is needed and the higher the power loss are. Obviously, for the conventional transparent antenna, there is a trade-off between the antenna efficiency and optical transparency. For example, the ITO with a thickness of 1.2 μm has an optical transparency of 60%, but a transparent patch antenna using it has a radiation efficiency of 20% at 5 GHz only [17]. One way to mitigate this problem is to use a tiny metal mesh grid in the order of tens of micrometers. Since good conductors are used in this method, the conductivity and hence the radiation efficiency can be improved. A much-improved transparency of 88% has been obtained by using a diamond-shaped metal grid with a thickness of 0.2 μm and a grid width of 3 μm. It was obtained by using a photolithography process [25]. The grid patch antenna made of Ag-alloy can be printed on organic light emitting diodes (OLEDs). Since it has an efficiency of ˜41%, it has become a new topic of antenna on display (AoD). This can be seen from the fact that numerous studies have focused on the AoD and transparent antennas using metal mesh grids [26]-[34].

The transparent antennas as discussed above have conduction currents on their radiating patches. In the second approach, the transparent radiator has no conduction current. The transparent water patch antenna [35], belongs to this category. This transparent antenna has a good transparency of 80% or more, with its efficiency higher than those of the transparent antennas as mentioned above. The DRAs also belongs to this category. Its dielectric constant &, should be higher than a certain value, e.g. &, >5, to obtain a good polarization purity [37]. Traditionally, DRAs are made of ceramic or composite materials. The first glass DRA has been proposed in 2009 [38], and K-9 glass was used in the demonstration. This kind of glass has a high optical transparency of more than 90%, being sufficient even for telescope lenses. The glass DRA has both high optical transparency (>90%) and high radiation efficiency (>90%), breaking the dilemma as found in the solid transparent antennas as discussed above. The glass DRA has been investigated for dual-function applications, including light covers [39], [40], decorations [37], mirrors [41], and focusing lenses of solar panels [38]. Different glass DRAs have been investigated, such as the multiband [40], circular-polarization [42], and dual-polarization DRAs.

On the other hand, omnidirectional antennas are desirable for indoor applications because they can provide a larger coverage. Polarization-diversity antenna can perform consistently and stably in different indoor environments as compared to the space-diversity antenna. At present, monopole antennas as mentioned above are commonly used in indoor wireless communication systems, which cannot provide the desirable polarization diversity and azimuthal omnidirectional coverage. Thus, it is useful to provide a polarization-diversity omnidirectional antenna for indoor applications. However, this kind of antenna usually requires multiple dielectric substrates, increasing the antenna complexity and cost.

### REFERENCES

The following references are referred to throughout this specification, as indicated by the numbered brackets:
1. J. Ding and Y. Wang, “A WiFi-based smart home fall detection system using recurrent neural network,” IEEE Trans. Consum. Electron., vol. 66, no. 4, pp. 308-317, November 2020.
2. C.-H. Lim, Y. Wan, B.-P. Ng, and C.-M. S. See, “A real-time indoor wifi localization system utilizing smart antennas,” IEEE Trans. Consum. Electron., vol. 53, no. 2, pp. 618-622, May 2007.
[3] “Global consumer Wi-Fi router market-forecast 2021 to 2026,” Research and Markets, January 2022. https://www.researchandmarkets.com/reports/5547568/global-consumer-wi-fi-router-market-forecast
[4] B. Sikdar, “A study of the environmental impact of wired and wireless local area network access,” IEEE Trans. Consum. Electron., vol. 59, no. 1, pp. 85-92, February 2013.
[5] J. De Mingo, P. L. Carro, and P. Garcia-Ducar, “Antenna effects in DVB-H mobile rebroadcasters,” IEEE Trans. Consum. Electron., vol. 55, no. 3, pp. 1155-1161 August 2009.
[6] J.-H. Lee and J.-G. Yook, “Improvement of radiation performance of mobile phone antenna using parasitic element,” IEEE Trans. Consum. Electron., vol. 56, no. 4, pp. 2411-2415 November 2010.
[7] G. C.-Y. Chen, K. K.-M. Chan, and K. Rambabu, “Miniaturized yagi class of antennas for GSM, WLAN, and WiMax applications,” IEEE Trans. Consum. Electron., vol. 56, no. 3, pp. 1235-1240 August 2010.
[8] P. L. Carro, J. de Mingo, and P. Garcia-Ducar, “On the integration of ultra wideband antennas in DVD players,” IEEE Trans. Consum. Electron., vol. 55, no. 2, pp. 334-341, May 2009.
[9] P. L. Carro, J. de Mingo, P. Garcia-Ducar, and C. Sánchez, “Performance degradation due to antenna impedance variability in DVB-H consumer devices,” IEEE Trans. Consum. Electron., vol. 56, no. 2, pp. 1153-1159 May 2010.
[10] J. Kraus, “Antennas since Hertz and Marconi,” IEEE Trans. Antennas Propag., vol. 33, no. 2, pp. 131-137, February 1985.
[11] Guglielmo Marconi, “Transmitting electrical signals,” U.S. Pat. No. 586,193, Jul. 13, 1897.
[12] C. A. Balanis, Antenna Theory. Hoboken, New Jersey: John Wiley & Sons, Inc., 2005.
[13] S. Uda, “On the wireless beam of short electric waves,” J. Inst. Electr. Eng. Jpn., vol. 46, no. 452, pp. 273-282, March 1926.
[14] R. Munson, “Conformal microstrip antennas and microstrip phased arrays,” IEEE Trans. Antennas Propag., vol. 22, no. 1, pp. 74-78, January 1974.
[15] S. Long, M. McAllister, and L. Shen, “The resonant cylindrical dielectric cavity antenna,” IEEE Trans. Antennas Propag., vol. 31, no. 3, pp. 406-412, May 1983.
[16] F. Colombel, X. Castel, M. Himdi, G. Legeay, S. Vigneron, and E. M. Cruz, “Ultrathin metal layer, ITO film and ITO/Cu/ITO multilayer towards transparent antenna,” IET Sci. Meas. Amp Technol., vol. 3, no. 3, pp. 229-234, May 2009.
[17] J. R. Saberin and C. Furse, “Challenges with optically transparent patch antennas,” IEEE Antennas Propag. Mag., vol. 54, no. 3, pp. 10-16, June 2012.
[18] A. S. Thampy and S. K. Dhamodharan, “Performance analysis and comparison of ITO- and FTO-based optically transparent terahertz U-shaped patch antennas,” Phys. E Low-Dimens. Syst. Nanostructures, vol. 66, pp. 52-58, February 2015.
[19] T. A. Elwi, H. M. Al-Rizzo, D. G. Rucker, E. Dervishi, Z. Li, and A. S. Biris, “Multi-walled carbon nanotube-based RF antennas,” Nanotechnology, vol. 21, no. 4, p. 045301, December 2009.
[20] S. Hakimi, S. K. A. Rahim, M. Abedian, S. M. Noghabaei, and M. Khalily, “CPW-fed transparent antenna for extended ultrawideband applications,” IEEE Antennas Wirel. Propag. Lett., vol. 13, pp. 1251-1254, 2014.
[21] H. Rmili, J.-L. Miane, H. Zangar, and T. Olinga, “Design of microstrip-fed proximity-coupled conducting-polymer patch antenna,” Microw. Opt. Technol. Lett., vol. 48, no. 4, pp. 655-660, 2006.
[22] Q. H. Dao, R. Tchuigoua, B. Geck, D. Manteuffel, P. von Witzendorff, and L. Overmeyer, “Optically transparent patch antennas based on silver nanowires for mm-wave applications,” in 2017 IEEE International Symposium on Antennas and Propagation & USNC/URSI National Radio Science Meeting, pp. 2189-2190 July 2017.
[23] B. Xi, X. Liang, Q. Chen, K. Wang, J. Geng, and R. Jin, “Optical transparent antenna array integrated with solar cell,” IEEE Antennas Wirel. Propag. Lett., vol. 19, no. 3, pp. 457-461, March 2020.
[24] C. Ding, L. Liu, and K.-M. Luk, “An optically transparent dual-polarized stacked patch antenna with metal-mesh films,” IEEE Antennas Wirel. Propag. Lett., vol. 18, no. 10, pp. 1981-1985 October 2019.
[25] J. Park, S. Y. Lee, J. Kim, D. Park, W. Choi, and W. Hong, “An optically invisible antenna-on-display concept for millimeter-wave 5 g cellular devices,” IEEE Trans. Antennas Propag., vol. 67, no. 5, pp. 2942-2952 May 2019.
[26] M. Kim et al., “Antenna-on-display concept on an extremely thin substrate for sub-6 GHz wireless applications,” IEEE Trans. Antennas Propag., vol. 70, no. 7, pp. 5929-5934 July 2022.
[27] D. Lee et al., “Dual-polarized dual-band antenna-on-display using via-less and single-layer topology for mmwave wireless scenarios,” IEEE Antennas Wirel. Propag. Lett., vol. 22, no. 5, pp. 1000-1004 May 2023.
[28] K. Fujita and M. Takahashi, “A concept of transparent antenna array on touch screen panel for sub-6 ghz cellular devices,” in 2021 IEEE International Symposium on Antennas and Propagation and USNC-URSI Radio Science Meeting (APS/URSI), pp. 3-4, December 2021.
[29] P. Duy Tung and C. W. Jung, “Optically transparent wideband dipole and patch external antennas using metal mesh for UHD TV applications,” IEEE Trans. Antennas Propag., vol. 68, no. 3, pp. 1907-1917 March 2020.
[30] B. Wu, X.-Y. Sun, H.-R. Zu, H.-H. Zhang, and T. Su, “Transparent ultrawideband halved coplanar Vivaldi antenna with metal mesh film,” IEEE Antennas Wirel. Propag. Lett., vol. 21, no. 12, pp. 2532-2536 December 2022.
[31] S. H. Kang and C. W. Jung, “Transparent patch antenna using metal mesh,” IEEE Trans. Antennas Propag., vol. 66, no. 4, pp. 2095-210 April 2018.
[32] E. N. Lee et al., “Modeling, simulation, and measurement of a transparent armor embedded meshed microstrip antenna,” in Proceedings of the 2012 IEEE International Symposium on Antennas and Propagation, pp. 1-2, July 2012.
[33] Y. Shi, W. J. Wang, and T. T. Hu, “A transparent SIW cavity-based millimeter-wave slot antenna for 5G communication,” IEEE Antennas Wirel. Propag. Lett., vol. 21, no. 6, pp. 1105-119 June 2022.
[34] G. Liu, M. R. Dehghani Kodnoeih, K. T. Pham, E. M. Cruz, D. González-Ovejero, and R. Sauleau, “A millimeter-wave multibeam transparent transmitarray antenna at Ka-band,” IEEE Antennas Wirel. Propag. Lett., vol. 18, no. 4, pp. 631-635, April 2019.
[35] J. Sun and K.-M. Luk, “A wideband and optically transparent water patch antenna with broadside radiation pattern,” IEEE Antennas Wirel. Propag. Lett., vol. 19, no. 2, pp. 341-345, February 2020.
[36] J. Sun and K.-M. Luk, “A wideband low cost and optically transparent water patch antenna with omnidirectional conical beam radiation patterns,” IEEE Trans. Antennas Propag., vol. 65, no. 9, pp. 4478-4485 September 2017.
[37] K. W. Leung, E. H. Lim, and X. S. Fang, “Dielectric resonator antennas: from the basic to the aesthetic,” Proc. IEEE, vol. 100, no. 7, pp. 2181-2193 July 2012.
[38] E. H. Lim and K. W. Leung, “Transparent dielectric resonator antennas for optical applications,” IEEE Trans. Antennas Propag., vol. 58, no. 4, pp. 1054-159 April 2010.
[39] K. W. Leung, Y. M. Pan, X. S. Fang, E. H. Lim, K.-M. Luk, and H. P. Chan, “Dual-function radiating glass for antennas and light covers-part I: omnidirectional glass dielectric resonator antennas,” IEEE Trans. Antennas Propag., vol. 61, no. 2, pp. 578-586, February 2013.
[40] K. W. Leung, X. S. Fang, Y. M. Pan, E. H. Lim, K. M. Luk, and H. P. Chan, “Dual-function radiating glass for antennas and light covers-part II: dual-band glass dielectric resonator antennas,” IEEE Trans. Antennas Propag., vol. 61, no. 2, pp. 587-597, February 2013.
[41] N. Yang, K. W. Leung, and E. H. Lim, “Mirror-integrated dielectric resonator antenna,” IEEE Trans. Antennas Propag., vol. 62, no. 1, pp. 27-32, January 2014.
[42] N. Yang, K. W. Leung, K. Lu, and N. Wu, “Omnidirectional circularly polarized dielectric resonator antenna with logarithmic spiral slots in the ground,” IEEE Trans. Antennas Propag., vol. 65, no. 2, pp. 839-844, February 2017.
[43] P. F. Hu, K. W. Leung, K. M. Luk, Y. M. Pan, and S. Y. Zheng, “Diversity glass antennas for tri-band WiFi applications,” Engineering, vol. 23, pp. 157-169, April 2023.
[44] W. Li, K. W. Leung, and N. Yang, “Omnidirectional dielectric resonator antenna with a planar feed for circular polarization diversity design,” IEEE Trans. Antennas Propag., vol. 66, no. 3, pp. 1189-1197 March 2018.
[45] X. Liu, K. W. Leung, and N. Yang, “Wideband horizontally polarized omnidirectional cylindrical dielectric resonator antenna for polarization reconfigurable design,” IEEE Trans. Antennas Propag., vol. 69, no. 11, pp. 7333-7342 November 2021.
[46] M. Zou and J. Pan, “Investigation of resonant modes in wideband hybrid omnidirectional rectangular dielectric resonator antenna,” IEEE Trans. Antennas Propag., vol. 63, no. 7, pp. 3272-3275 July 2015.
[47] X. S. Fang, L. P. Weng, and Y.-X. Sun, “Slots-coupled omnidirectional circularly polarized cylindrical glass dielectric resonator antenna for 5.8-GHz WLAN application,” IEEE Access, vol. 8, pp. 204718-204727, 2020.
[48] T. Liu, H. Yang, Y. He, and J. Lu, “A TE01 mode omnidirectional dielectric resonator antenna excited by a special configuration,” IEEE Trans. Antennas Propag., vol. 66, no. 12, pp. 7339-7341 December 2018.
[49] N. Yang and K. W. Leung, “Size reduction of omnidirectional cylindrical dielectric resonator antenna using a magnetic aperture source,” IEEE Trans. Antennas Propag., vol. 68, no. 4, pp. 3248-3253 April 2020.
[50] L. Zou, D. Abbott, and C. Fumeaux, “Omnidirectional cylindrical dielectric resonator antenna with dual polarization,” IEEE Antennas Wirel. Propag. Lett., vol. 11, pp. 515-518, 2012.
[51] J. Lai et al., “Design of a dual-polarized omnidirectional dielectric resonator antenna for capsule endoscopy system,” IEEE Access, vol. 9, pp. 14779-14786, 2021.

### SUMMARY OF INVENTION

Accordingly, the present invention, in one aspect, is a dielectric resonator antenna, which includes a dielectric resonator and a substrate on which a planar feeding circuit is configured. The dielectric resonator is located on a first side of the substrate. The planar feeding circuit contains a first feeding part and a second feeding part. The first and second feeding parts are adapted to excite two orthogonal DRA modes in a same frequency band.

In some embodiments, each of the first feeding part and the second feeding part has a substantially circular or round shape. The first feeding part and the second feeding part are concentrically arranged. The first feeding part is located radially outer than the second first feeding part on the substrate.

In some embodiments, the first feeding part is an Alford loop that includes a plurality of angular strips. Between every two adjacent angular strips there is configured a gap.

In some embodiments, the plurality of angular strips is connected to a 1-4 power divider which is located radially outer than the plurality of angular strips.

In some embodiments, the substrate further contains a first shorting via at a location of an input of the 1-4 power divider. The first shorting via is adapted to connect the power divider to a first feedline.

In some embodiments, the first shorting via is located near a circumference of the substrate.

In some embodiments, the second feeding part contains a circular patch located at a center of the substrate, and a plurality of shorted stubs extending from the circular patch.

In some embodiments, the plurality of shorted stubs extends from the circular patch along radial directions of the circular patch.

In some embodiments, the second feeding part contains a circular patch located at a center of the substrate and a plurality of shorted stubs. Each shorted stub extends from the circular patch toward a corresponding one of the gaps.

In some embodiments, the substrate further contains a second shorting via located at a center of the substrate. The second shorting via is adapted to connect the circular patch to a second feedline.

In some embodiments, the dielectric resonator is made of glass.

In some embodiments, the dielectric resonator has a substantially cylindrical shape.

According to another aspect of the invention, there is provided an electronic apparatus which includes a body, a lighting device located within or attached to the body, and a dielectric resonator antenna as mentioned above. The dielectric resonator antenna is attached to the body. The dielectric resonator of the dielectric resonator antenna is made of glass, which is adapted to allow light emitted by the lighting device to pass through the dielectric resonator and be emitted to an outside of the electronic apparatus.

In some embodiments, the substrate of the dielectric resonator is formed with an aperture. The lighting device located on a second side of the substrate opposite to the first side of the substrate. The aperture is adapted to allow light emitted by the lighting device to pass through and arrive at the dielectric resonator.

According to a further aspect of the invention, there is provided an antenna apparatus comprising: a substrate, a dielectric resonator arrangement arranged on one side of the substrate, a first feed arrangement operably coupled with the dielectric resonator arrangement for operating the antenna apparatus as a first linearly polarized antenna, and a second feed arrangement operably coupled with the dielectric resonator arrangement for operating the antenna apparatus as a second linearly polarized antenna different from the first linearly polarized antenna. The first feed arrangement comprises a first feed circuit disposed between the substrate and the dielectric resonator arrangement. The second feed arrangement comprises a second feed circuit disposed between the substrate and the dielectric resonator arrangement.

The antenna apparatus is preferably an omnidirectional antenna operable to generate a generally omnidirectional radiation pattern.

The antenna apparatus may be used for transmitting and/or receiving electromagnetic radiation or signals. The first linearly polarized antenna may be used for transmitting and/or receiving electromagnetic radiation or signals. The second linearly polarized antenna may be used for transmitting and/or receiving electromagnetic radiation or signals.

In some embodiments, the first linearly polarized antenna is a first linearly polarized omnidirectional antenna operable to generate a generally omnidirectional radiation pattern.

In some embodiments, the second linearly polarized antenna is a second linearly polarized omnidirectional antenna operable to generate a generally omnidirectional radiation pattern.

In some embodiments, the antenna apparatus is operable as the first linearly polarized antenna and the second linearly polarized antenna simultaneously.

In some embodiments, the antenna apparatus is operable as the first linearly polarized antenna and the second linearly polarized antenna selectively (e.g., one at a time).

In some embodiments, the antenna apparatus is operable as the first linearly polarized antenna and the second linearly polarized antenna independently.

In some embodiments, the first linearly polarized antenna is a vertically polarized antenna (for generally vertical polarization).

In some embodiments, the second linearly polarized antenna is a horizontally polarized antenna (for generally horizontal polarization).

The substrate may include one or more dielectric substrate layers. For example, the substrate may be a PCB substrate. The substrate may be in the form of a disc, e.g., a generally rounded disc.

In some embodiments, the dielectric resonator arrangement comprises a dielectric resonator element. In some embodiments, the dielectric resonator arrangement consists only of a dielectric resonator element. The first feed circuit may be disposed between the substrate and the dielectric resonator element. The second feed circuit may be disposed between the substrate and the dielectric resonator element.

In some embodiments, the dielectric resonator element comprises or is a dielectric resonator block. The dielectric resonator block may be a solid block without any holes, openings, hollows, voids, etc. For example, the dielectric resonator block may be shaped as a cylinder, a prism, or other regular or irregular shape. The cylinder may be a right cylinder. The cylinder may be a circular cylinder, an elliptic cylinder, a parabolic cylinder, a hyperbolic cylinder, etc. The prism may be a right prism. The prism may be a triangular prism, a rectangular prism, cube, a polygonal prism, etc. In some examples, the dielectric resonator block may be shaped as an aesthetically shaped object/article.

In some embodiments, the dielectric resonator element is at least partly substantially transparent (colored or colorless) or translucent (colored or colorless). Optionally, the dielectric resonator element includes one or more substantially transparent portions (colored or colorless) and/or one or more translucent portions (colored or colorless). Optionally, the dielectric resonator element is entirely substantially transparent or is entirely translucent.

In some embodiments, the dielectric resonator element is at least partly made of one or more substantially transparent materials and/or one or more translucent materials. Optionally, the dielectric resonator element is entirely made of one or more substantially transparent materials and/or one or more translucent materials. The one or more substantially transparent materials and/or one or more translucent materials may be glass, crystal, ceramics, composites, etc.

In some embodiments, the antenna apparatus further comprises a decorative arrangement arranged in or on the dielectric resonator element. Optionally, the decorative arrangement comprises a picture or a pattern applied in or on the dielectric resonator element. For example, the picture or pattern may be printed in or on the dielectric resonator element. For example, the picture or pattern may be etched in or on the dielectric resonator element. For example, the picture or pattern may be stamped in the dielectric resonator element. For example, the picture or pattern may be engraved on the dielectric resonator element. For example, the picture or pattern may be impressed in or on the dielectric resonator element. For example, the picture or pattern may be embedded in the dielectric resonator element.

In some embodiments, the first feed arrangement is operable to excite a transverse magnetic (TM) mode of the dielectric resonator arrangement. For example, the transverse magnetic (TM) mode may comprise a TM01d mode.

In some embodiments, the first feed circuit is generally planar.

In some embodiments, the first feed circuit comprises an electrically conductive patch element. Optionally, the electrically conductive patch element is arranged such that in plan view the electrically conductive patch element is located generally centrally of the substrate. Optionally, the electrically conductive patch element is generally circular in plan view.

In some embodiments, the first feed circuit further comprises a plurality of shorted stubs each extending from the electrically conductive patch element. For example, the shorted stubs may each extend generally radially from the electrically conductive patch element.

In some embodiments, the plurality of shorted stubs are angularly spaced apart. In some embodiments, the plurality of shorted stubs are angularly spaced apart generally evenly. In one example, the plurality of shorted stubs consist of four shorted stubs angularly spaced apart by about 90 degrees, forming two pairs of generally opposed short stubs.

In some embodiments, the first feed arrangement further comprises a plurality of shorting vias each connected with a respective one of the shorted stubs.

In some embodiments, each of the shorted stubs includes a respective inner end located closer to the electrically conductive patch element and a respective outer end located further away from the electrically conductive patch element, and each of the shorting vias is respectively connected at or near the outer end of a corresponding one of the shorted stubs. The inner ends may be radially inner ends and the outer ends may be radially outer ends.

In some embodiments, the first feed arrangement further comprises a probe feed electrically connected with the first feed circuit. In some embodiments, the probe feed is operable to provide a feed port on another side of the substrate opposite the one side of the substrate. In some embodiments, the antenna apparatus further comprises a ground plane arranged on another side of the substrate opposite the one side of the substrate, and the probe feed comprises: a first conductor extending through the substrate and electrically connected with the first feed circuit and a second conductor electrically connected with the ground plane. In some embodiments, the probe feed comprises a coaxial feed probe. The probe feed may be implemented using an RF connector such as SMA connector, SMP connector, N connector, SMB connector, etc.

In some embodiments, the second feed arrangement is operable to excite a transverse electric (TE) mode of the dielectric resonator arrangement. For example, the transverse electric (TE) mode may comprise a TE01d+1 mode.

In some embodiments, the second feed circuit is generally planar.

In some embodiments, the second feed circuit comprises a plurality of electrically conductive strip elements arranged generally around the first feed circuit (or the electrically conductive patch element of the first feed circuit). Optionally, the plurality of electrically conductive strip elements have generally the same shape and/or size (e.g., area).

In some embodiments, the plurality of electrically conductive strip elements are generally arc-shaped electrically conductive strip elements.

In some embodiments, the plurality of electrically conductive strip elements are angularly spaced apart. In some embodiments, the plurality of electrically conductive strip elements are angularly spaced apart generally evenly.

In some embodiments, the plurality of electrically conductive strip elements are arranged on a generally circular path in plan view. Optionally, in plan view, the generally circular path is generally coaxial with a center of the first feed circuit (e.g., the electrically conductive patch element of the first feed circuit).

In some embodiments, the second feed arrangement further comprises a power divider circuit electrically connected with the plurality of electrically conductive strip elements.

In some embodiments, the power divider circuit is generally planar.

In some embodiments, the power divider circuit comprises a plurality of electrically conductive strips arranged on the one side of the substrate.

In some embodiments, the second feed arrangement further comprises a probe feed electrically connected with the power divider circuit. In some embodiments, the probe feed is operable to provide a feed port on another side of the substrate opposite the one side of the substrate. In some embodiments, the antenna apparatus further comprises a ground plane arranged on another side of the substrate opposite the one side of the substrate, and the probe feed comprises: a first conductor extending through the substrate and electrically connected with the power divider circuit and a second conductor electrically connected with the ground plane. In some embodiments, the probe feed comprises a coaxial feed probe. The probe feed may be implemented using an RF connector such as SMA connector, SMP connector, N connector, SMB connector, etc.

Optionally, the substrate comprises one or more slots, e.g., a plurality of slots, for enabling passage of light. In some embodiments, the plurality of slots include the same shape and/or size (e.g., area). In some embodiments, the plurality of slots include different shapes and/or sizes (e.g., areas).

Optionally, the plurality of slots comprise a plurality of generally arc-shaped slots that are angularly spaced apart. Optionally, the plurality of slots comprise a plurality of generally arc-shaped slots that are angularly spaced apart generally evenly.

Optionally, the plurality of slots are arranged on a generally circular path in plan view. Optionally, in plan view, the generally circular path of the plurality of slots is generally coaxial with the generally circular path of the plurality of electrically conductive strip elements of the second feed circuit and/or a center of the electrically conductive patch element of the first feed circuit.

Optionally, the one or more slots are disposed such that in plan view the one or more slots are located in an area between the first feed circuit and the second feed circuit. In some embodiments, the one or more slots include a plurality of slots, and the plurality of slots are disposed such that in plan view each of the plurality of slots is respectively located in an area between the electrically conductive patch element of the first feed circuit and a corresponding one of the plurality of electrically conductive strip elements.

Optionally, the antenna apparatus further comprises a light source for providing light to or through the dielectric resonator arrangement.

Optionally, the light source is at least partly received in the one or more slots. For example, the light source may include one or more LEDs.

Optionally, the light source comprises a plurality of lights, e.g., LEDs.

Optionally, the one or more slots comprise a plurality slots, and each of the plurality of slots respectively at least partly receives at least one of the plurality of lights.

Optionally, the light source is arranged outside of (hence not received by) the one or more slots. Optionally, the light source is optically aligned with the one or more slots.

In some embodiments, the antenna is operable in, at least, 2.4 GHz frequency band. Optionally, the first linearly polarized antenna and the second linearly polarized antenna are both operable in, at least, the 2.4 GHz frequency band. In some embodiments, the antenna is operable not only at the 2.4 GHz frequency band, but also at other frequency, frequencies, or frequency band(s).

In a second aspect, there is provided an electronic device comprising the antenna apparatus of the first aspect. The electronic device may be a communication device. The communication device may be a router, e.g., a Wi-Fi router.

Other features and aspects will become apparent by consideration of the detailed description and accompanying drawings. Any feature(s) described herein in relation to one aspect or embodiment may be combined with any other feature(s) described herein in relation to any other aspect or embodiment as appropriate and applicable.

Terms of degree such that “generally”, “about”, “substantially”, or the like, are used, depending on context, to account for manufacture tolerance, degradation, trend, tendency, imperfect practical condition(s), etc. For example, the term “generally omnidirectional” means that strict omnidirectional may not be essential; the term “general horizontal polarization” means that strict horizontal polarization may not be essential; the term “general vertical polarization” means that strict vertical polarization may not be essential.

Unless otherwise specified, when a value is modified by terms of degree, such as “about”, such expression may include the stated value ±20%, ±15%, ±10%, ±5%, ±2%, or ±1%.

Unless otherwise specified, the terms “connected”, “coupled”, “mounted” or the like, are intended to encompass both direct and indirect connection, coupling, mounting, etc.

One can see that embodiments of the invention therefore provide a dielectric resonator antenna that is suitable for using in wireless communication systems to provide large signal coverage and stable wireless access for mobile terminals. Due to its polarization diversity, the antenna can be used to replace two commercial Wi-Fi antennas. It can simultaneously be used as a projection device for decoration and advertising. Since the antenna have a compact size, a beautiful outlook, and dual functions, it will be very useful for indoor applications.

In addition, previous polarization-diversity omnidirectional antenna designs require multiple substrates for printing feeding circuits or drilling a hole in the dielectric resonator to accommodate the feeding probe. It leads to a high complexity and high cost. In addition, drilling a hole in the glass is not good for a beautiful outlook. Compared with these existing designs, DRA antennas provided by embodiments of the invention are compact and low-cost. In some embodiments, only a single substrate is required for the antenna, and its dielectric resonator does not need to be drilled.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 shows the side view of a single-substrate omnidirectional dielectric resonator antenna according to a first embodiment of the invention.

FIG. 2 shows a top view of the substrate and the planar feeding circuit on top of the substrate in the antenna of FIG. 1.

FIG. 3 shows a computer-rendered perspective view of the antenna of FIG. 1.

FIG. 4a shows a computer-rendered perspective view of a DRA which contains circular patch with four shorted stubs.

FIG. 4b shows a computer-rendered perspective view of a DRA which contains an Alford loop and four radial feedlines.

FIG. 4c shows a computer-rendered perspective view of a DRA which contains two substrates carrying respectively a circular patch and an Alford loop.

FIG. 5a shows simulated S-parameters of the antenna in FIG. 4a.

FIG. 5b shows simulated S-parameters of the antenna in FIG. 4b.

FIG. 5c shows simulated S-parameters of the antenna in FIG. 4c.

FIG. 6a shows the simulated E-field distribution of the antenna of FIG. 4a.

FIG. 6b shows the simulated radiation pattern of the antenna of FIG. 4a.

FIG. 7a shows the simulated E-field distribution of the antenna of FIG. 4b.

FIG. 7b shows the simulated radiation pattern of the antenna of FIG. 4b.

FIG. 8a shows the simulated E-field distribution of the DR TM_{01δ} mode of the antenna of FIG. 4c.

FIG. 8b shows the simulated radiation pattern of the DR TM_{01δ} mode of the antenna of FIG. 4c.

FIG. 9a shows the simulated E-field distribution of the DR TE_{01δ+1} mode of the antenna of FIG. 4c.

FIG. 9b shows the simulated radiation pattern of the DR TE_{01δ+1} mode of the antenna of FIG. 4c.

FIG. 10 shows simulated S-parameters of the antenna in FIGS. 1-3.

FIG. 11 is a flowchart illustrating simulated S-parameters of the antenna in FIGS. 1-3.

FIG. 12a is a photo a Wi-Fi router carrying a prototype of the antenna in FIGS. 1-3.

FIG. 12b shows various glass dielectric resonators with different pictures and/or characters.

FIG. 13a shows simulated and measured S-parameters of a prototype of the antenna of FIGS. 1-3.

FIG. 13b shows simulated and measured antenna peak gains of the prototype.

FIG. 14a shows simulated and measured radiation pattern at vertically polarized (VP) Port 1 of the prototype.

FIG. 14b shows simulated and measured radiation pattern at horizontally polarized (HP) Port 2 of the prototype.

FIG. 15 shows measured envelope correlation coefficients (ECCs) of the prototype.

FIG. 16 shows throughput comparison between commercial monopole antenna pair and the prototype at different indoor locations, where the two antennas are mounted on the same router and their antenna gains are close to each other.

FIG. 17 shows a top view of the substrate and the planar feeding circuit on top of the substrate in a single-substrate omnidirectional dielectric resonator antenna according to a further embodiment of the invention.

FIG. 18 illustrates the installation of an electronic apparatus installed to a ceiling that contains the antenna of FIG. 17, and also used as a projection device.

FIG. 19 shows a photo of a prototype of the electronic apparatus of FIG. 18, which shows LED strings exposed in apertures formed on the substrate.

In the drawings, like numerals indicate like parts throughout the several embodiments described herein.

### DETAILED DESCRIPTION

Referring now to FIGS. 1-3, a first embodiment of the present invention is a single-substrate omnidirectional dielectric resonator antenna 20, which is adapted to excite two orthogonal (e.g., vertical and horizontal) DRA modes under a same frequency, thus achieving polarization diversity. The antenna 20 includes a dielectric resonator 22 which in this embodiment has a cylindrical shape and is made of glass, and a single substrate 24. The substrate 24 has a round shape and its diameter is larger than that of the dielectric resonator 22. The dielectric resonator 22 has a dielectric constant εᵣ, a diameter D, and a height H, while the substrate has a dielectric constant of εᵣ₁, a thickness of hₛ, and a radius of r_{g}. The dielectric resonator 22 is located on a first side of the substrate 24, and they are concentric. On a second side of the substrate 24 there is first port 40 and a second port 42 configured. The second side of the substrate 24 can be considered as a ground plane of the antenna 20. The two ports 40, 42 are respectively responsible for HP and VP excitations, and will be described in more details later, but from FIG. 1 one can see that the second port 42 is located at a center of the circular shape of the substrate 24, while the first port 40 is off-center, and in particular is located near a circumference of the substrate 42.

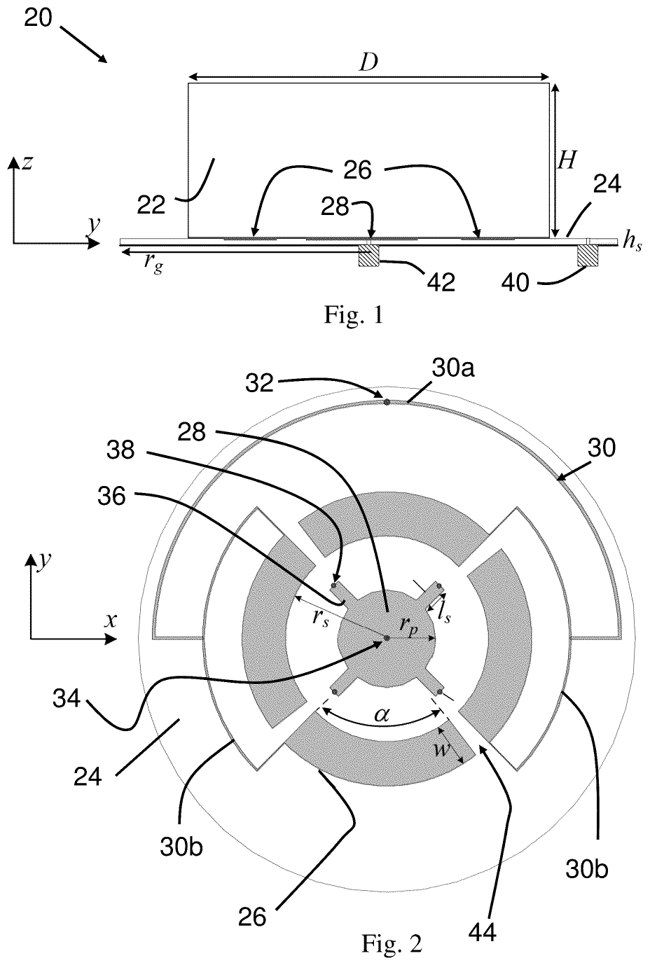

On the substrate 24 there is configured a planar feeding circuit which for example can be printed on the first side of the substrate 24. The planar feeding circuit 24 contains two parts, namely a first feeding part and a second feeding part. Both the first feeding part and the second feeding part are co-planar, and they are respectively adapted to excite one of the two orthogonal DRA modes (namely HP and VP), as will be described in more details later. Although the two RA modes excited by the first and second feeding parts are orthogonal to each other, they are in the same frequency band. As best shown in FIG. 2, the first feeding part is an Alford loop that is concentric with the substrate 24, and the Alford loop contains a plurality segments each of which being an angular strip 26. There are four angular strips 26 as shown in FIG. 2, each spanning a subtended angle of a that is close to 90 degrees. The width of each angular strip 26 is w, and each angular strip 26 is offset from a center of the substrate 24 by a distance of rₛ. Between every two angular strips 26 there is a gap 44 formed.

The Alford loop is connected to a 1-4 power divider 30 which equally splits an input power into four portions to feed each of the four angular strips 26. The power divider 30 contains a first stage 30a that has the general shape of a semi-circle, and is located near the circumference of the substrate 24. The arc shape of the first stage 30a spans 180 degrees. At a middle point of the first stage 30a on its arc shape, there is configured a first shorting via 32 through the substrate 24 so that the power divider 30 on the first side of the substrate 24 is electrically connected to the first port 40 on the second side of the substrate 24. At the two ends of its arc shape, the first stage 30a is respectively connected to two second stages 30b of the power divider 30. One can see from FIG. 2 that each of the second stages 30b is shifted 90 degrees from the first stage 30a, and the two second stages 30b are separated from each other by 180 degrees along the circumference of the substrate 24. Each of the two second stages 30b spans 90 degrees. The first stage 30a is connected to a middle point of the arc shape of each second stage 30b. In turn, each second stage 30b is connected to two angular strips 26 at one end of each of the two angular strips 26.

Turning to the second feeding part, one can see from FIG. 2 that the second feeding part contains a circular patch 28 at the center of the substrate 24 and is being concentric with the Alford loop of the first feeding part. The circular patch 28 has a radius of rₚ. There are four shorted stubs 36 connected to the circular patch 28 and extend therefrom along radial directions outward. Each shorted stub 36 has a length of lₛ. The shorted stubs 36 are equidistantly separated from each other along the circumferential direction, so they are offset from each other by 90 degrees. Each shorted stub 36 corresponds to one of the four gaps 44, and points toward the latter.

The circular patch 28 is fed at its center, which is also the center of the substrate 24. There is a second shorting via 34 configured at the center of the substrate 24 through which the circular patch 28 on the first side of the substrate 24 is electrically connected to the second port 42 on the second side of the substrate 24. Both the first port 40 and the second port 42 in one implementation are connectors for coaxial probes (which are feedlines to the antenna 20). In one example, the connectors each have an inner conductor extending through the substrate 24 and electrically connected with the power divider 30 or the circular patch 28 on the first side of the substrate 24. A ground plane at the second side of the substrate 24 includes a corresponding hole such that the inner conductor does not contact the ground plane). An outer conductor of the connector is electrically connected with the ground plane. In addition, at the free end of each of the shorted stub 36, there is configured a third shorting via 38.

In one implementation, the antenna 20 may have the following dimensions and properties (with reference to FIGS. 1-2): εᵣ=6.85, D=59 mm, H=24 mm, rₚ=8.8 mm, lₛ=3 mm, rₛ=16.3 mm, α=83°, w=7 mm, hₛ=0.813 mm, εᵣ₁=3.55, r_{g}=80 mm. Loss tangent of glass: tanδ=0.01, and loss tangent of substrate: tanδ=0.0027.

In the antenna 20, the second feeding part is adapted to excite the DR TM_{01δ} mode for vertical polarization. The first feeding part in contrast is adapted to excite the DR TE_{01δ+1} mode for horizontal polarization. Next, the design methodology of the antenna 20 shown in FIGS. 1-3 will be explained.

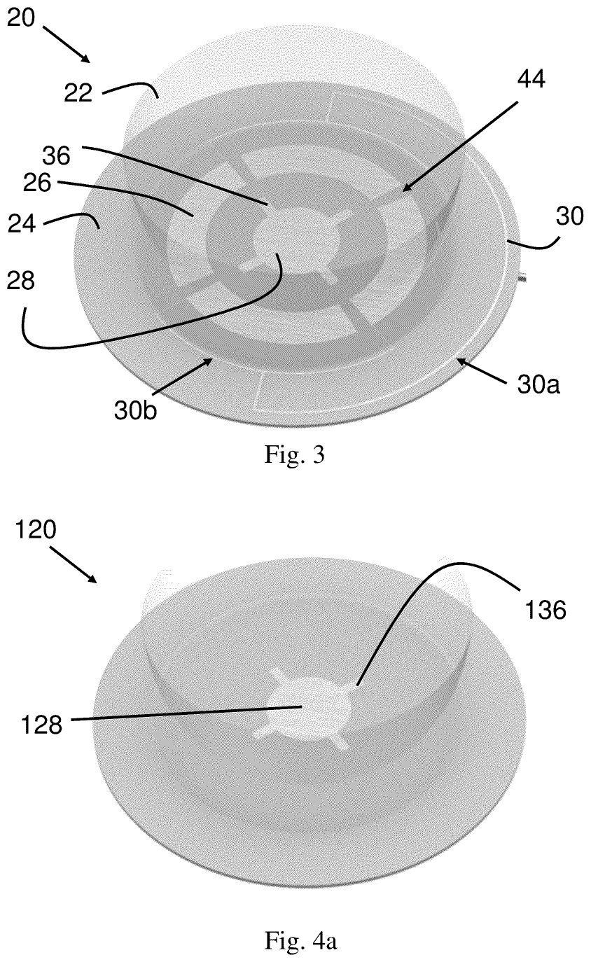

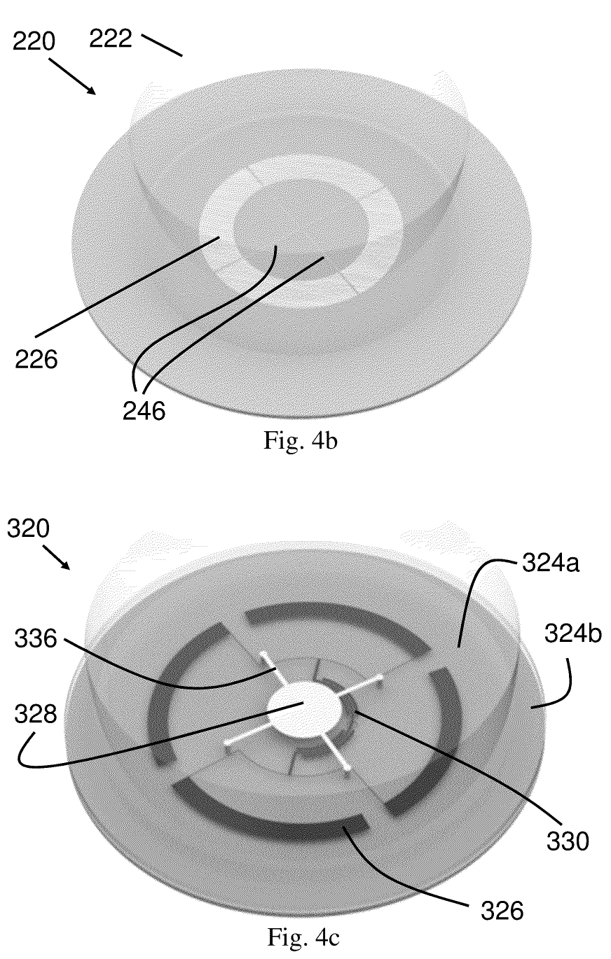

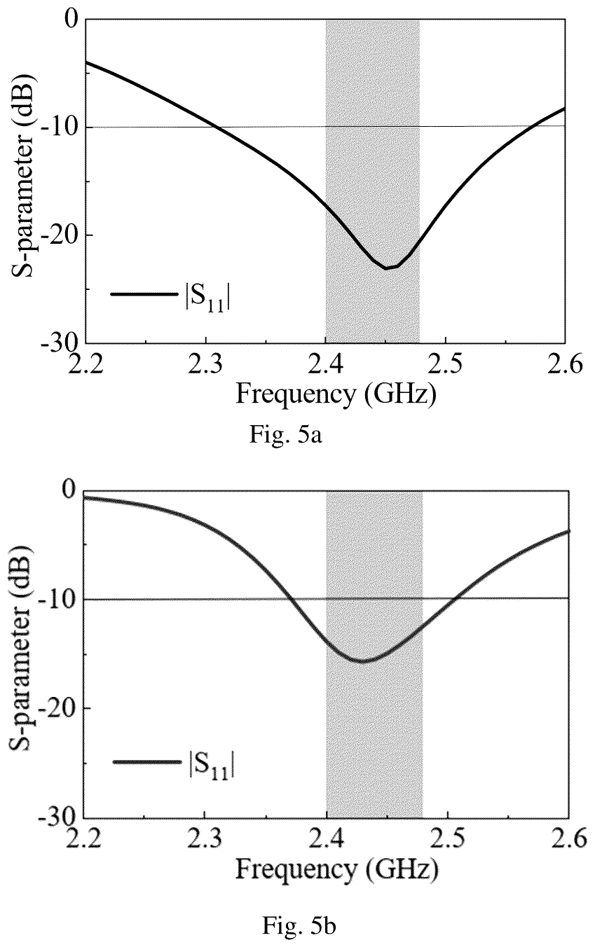

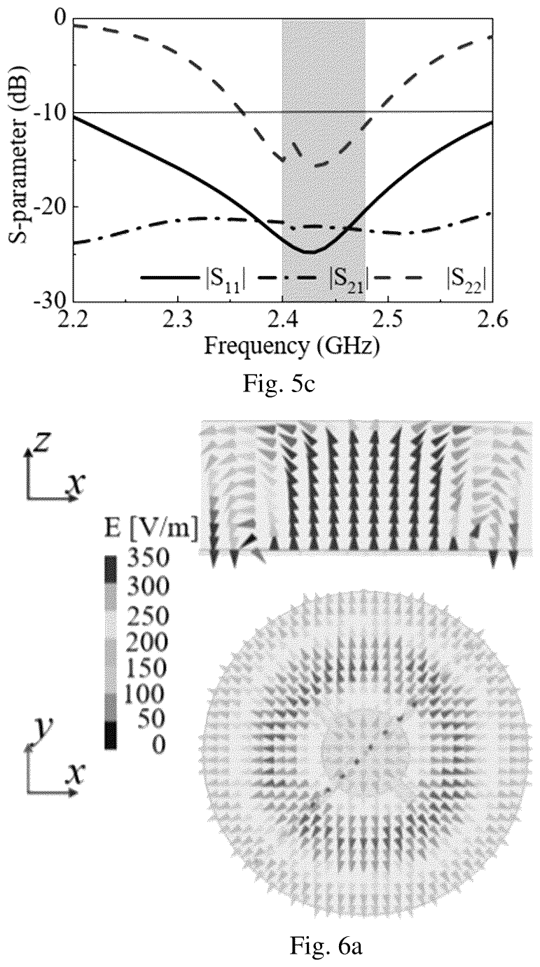

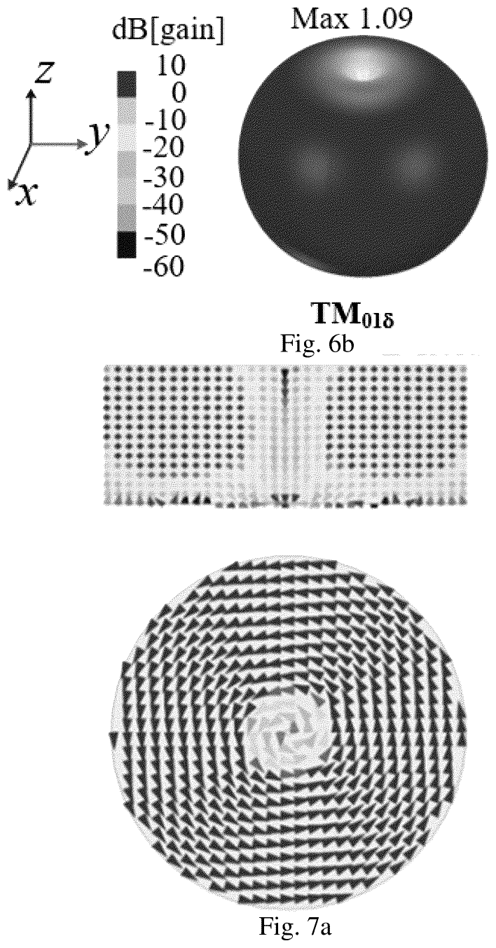

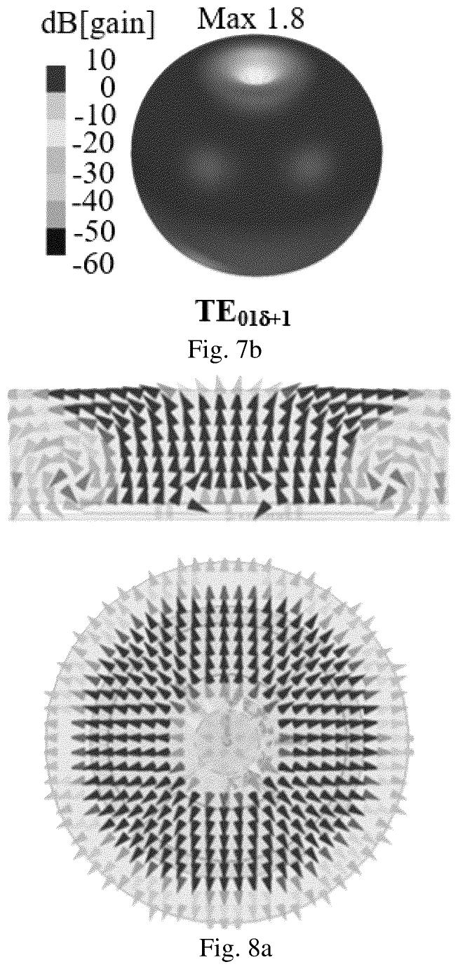

It is desirable to use a planar feeding circuit for a glass because it can reduce the machining complexity and is convenient for the aesthetic appearance. On this basis, FIG. 4a shows an antenna 120 that contains a circular patch 128 and four shorted stubs 136. FIG. 4b shows another antenna 220 that contains an Alford loop with four angular strips 226. Both the antennas 120, 220 are designed at 2.4 GHz for ease of comparison, and their reflection coefficients are shown in FIGS. 5a and 5b respectively. It can be seen that the antenna 120 with the circular patch 128 and the shorted stubs 136 has a resonance at 2.45 GHz. The E-field distribution and radiation pattern of the antenna 120 are shown in FIG. 6a and FIG. 6b respectively, indicating the DR TM_{01δ} mode. This resonant mode gives an azimuthally omnidirectional radiation pattern with vertical polarization.

For the antenna 220 in FIG. 4b, the antenna is fed by half of the Alford loop, and the other half part is replaced by the ground plane to avoid interference with the circuits under the ground plane. It can be observed from FIG. 5b that the antenna 220 also has a resonance in this frequency band (2.45 GHz). This resonant mode shows a ring-shaped E-field pattern in the xoy plane, indicating the DR TE_{01δ+1} mode. It is equivalent to a vertical magnetic dipole and gives an azimuthally omnidirectional radiation pattern with horizontal polarization. As the four radial feed lines 246 of the half-Alford loop are at the bottom of the dielectric resonator 222 that is made of glass, the four radial feed lines 246 will cause some radial E-field and degrade the cross-polarization level. From this analysis, it was found that a smaller distance between the angular strips 226 can enhance the loop current and reduce the cross-polarization to some extent.

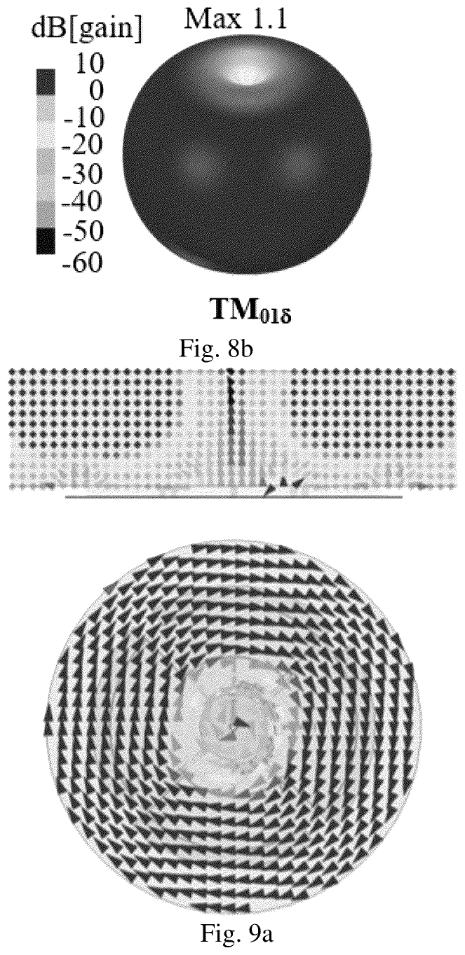

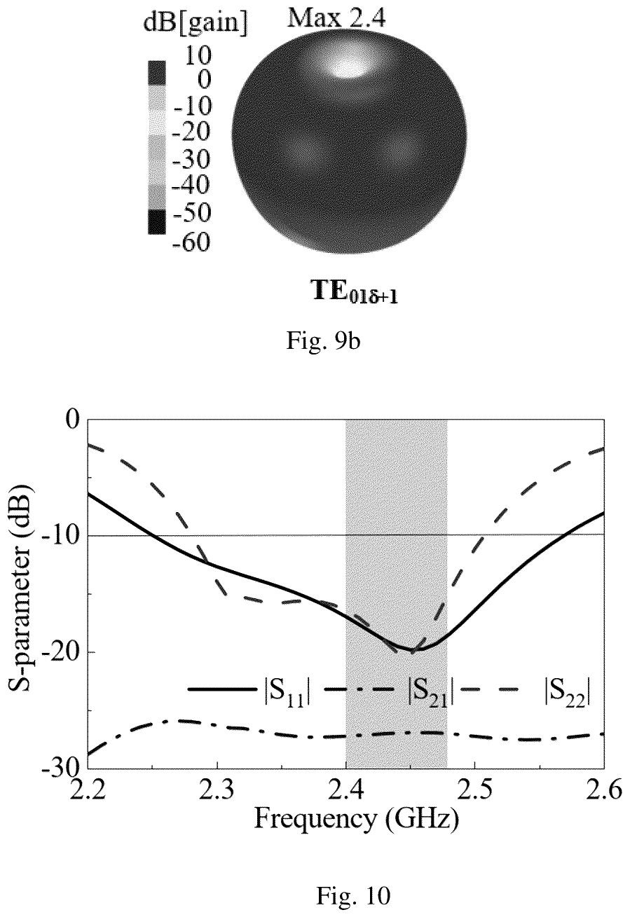

Although the omnidirectional radiation performance can be obtained using the two planar feed circuits (such as those in FIG. 4a and FIG. 4b) individually, it is not easy to combine the two planar feed circuits to obtain polarization diversity. This is because the two feed circuits must occupy the central area of the substrate. To combine them, two substrates 324a, 324b are used to support the feed lines in the antenna 320, as shown in FIG. 4c. The circular patch 328 with four shorted stubs 336 is placed on the top layer of the upper substrate 324a, while the Alford loop 326 and its feed circuits (not shown) are placed on the top of the lower substrate 324b. In addition, an 1-4 power divider 330 is used to replace the feeding radial lines (e.g., radial lines 246 in FIG. 4b) of the Alford loop to avoid the overlapping of the two feeding coaxial probes. The initial dimensions of the DR (dielectric resonator) can be determined by the resonant frequencies of the TM_{01δ} and TE_{01δ+1} modes. The antenna 320 obtains polarization diversity in the 2.4 GHz Wi-Fi band with high isolation of more than 20 dB, as shown in FIG. 5c. It can be seen from the E-filed distributions and radiation patterns in FIGS. 8a-9b that both DR TM_{01δ} and TE_{01δ+1} modes are well excited in the antenna 320.

Polarization diversity has been achieved in the antenna 320, but two substrates are required to design the feed networks. This is not compact and simple enough for consumer applications. To simplify the feed circuits and thus use one PCB only, a planar feed scheme on a single PCB substrate has therefore been conceived which is shown in FIGS. 1-3 for the antenna 20. As mentioned above, the Alford loop of angular strips 26, and the circular patch 28 with shorted stubs 36 are placed on the same layer. To avoid overlapping of the two feeding circuits, the 1-4 power divider 30 feeding the Alford loop is placed on the outside of the loop. It should be noted that although the antenna structure is simplified, the radiation performance is not degraded. It was found that the E-field distribution of the proposed antenna is similar to that of the antenna 320. The desired omnidirectional radiation pattern is still maintained for both ports of antenna 20. Since the resonant mode of the loop is generated at 2.32 GHz and merged with the DR TE_{01δ+1} mode, the bandwidth of the horizontally polarized port (which is the first port 40) is increased to 9.6% (2.28-2.51 GHz). Because the bandwidth of the vertically polarized port (which is the second port 42) is much wider, the overlapped bandwidth of the two ports is 9.6% as shown in FIG. 10 which fully covers the 2.4 GHz Wi-Fi band.

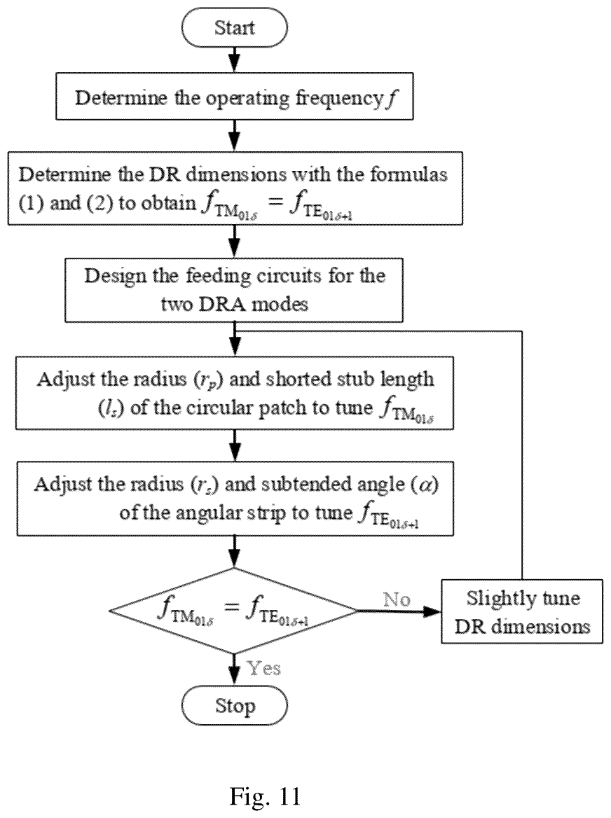

A design guideline is given in FIG. 11 to facilitate designs of the polarization-diversity glass antenna. The resonant frequency of the TM_{01δ} and TE_{01δ+1} modes can be calculated by using (1) and (2), respectively:

$${f}_{{TM}_{01 δ}} = \frac{c}{π D} \sqrt{\frac{{3.83}^{2} + {( \frac{π D}{4 H} )}^{2}}{{ε}_{r} + 2}} \qquad ( 1 )$$

$${f}_{{TM}_{01 δ + 1}} = \frac{2.2 \; 08 c}{π D \sqrt{{ε}_{r} + 1}} [ 1.0 + 0.7013 \times \frac{D}{2 H} - 2.713 \times 1 {0}^{- 3} {( \frac{D}{2 H} )}^{2} ] \qquad ( 2 )$$

where c, D, and H are the speed of light in vacuum, DR diameter, and DR height, respectively.

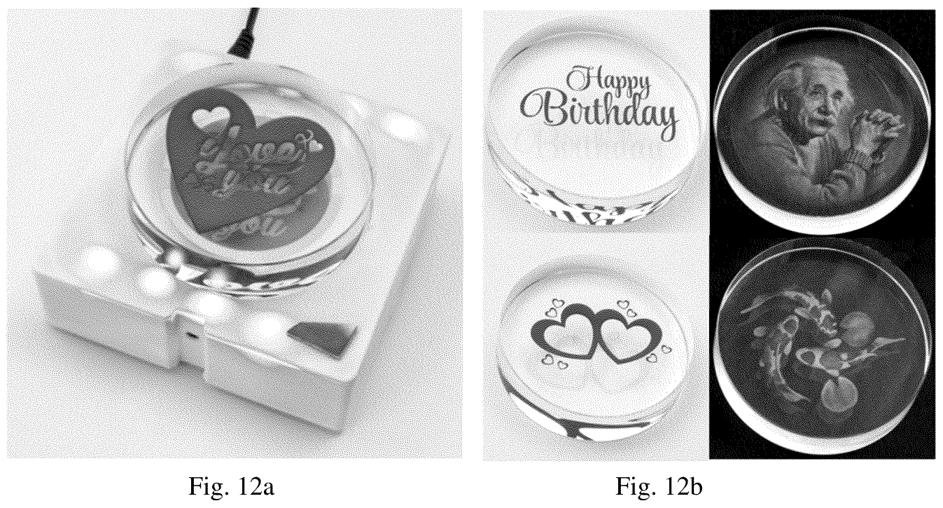

Next, the description goes to that of a prototype of the antenna 20 which was fabricated and measured to verify the simulation. The feeding circuits were fabricated on a substrate with a dielectric constant of εᵣ₁=3.55 and a thickness of hₛ=0.813 mm, while the DR was fabricated using K-9 glass (εᵣ=6.85, tanδ=0.01). FIG. 12a shows a photograph of the omnidirectional glass DRA prototype mounted in a WiFi router, which is packaged by a 3D-printed casing. FIG. 12b shows various designs of the glass dielectric resonator as different image and/or characters could be formed on the glass. Although the dimensions of the glass should be fixed to maintain the operating band, a wide variety of images can be customized and engraved on the surface and inside the glass with almost no effect on the radiation performance. This is because the thickness of the engraving is much smaller than the operating wavelength, and the removed part is very small compared to the whole. This feature is highly desirable for consumer electronics. In the experiment related to the prototype, the S-parameters were measured using an Agilent E5071C 4-port network analyzer, whereas the radiation patterns and gains were obtained using a Satimo Starlab system.

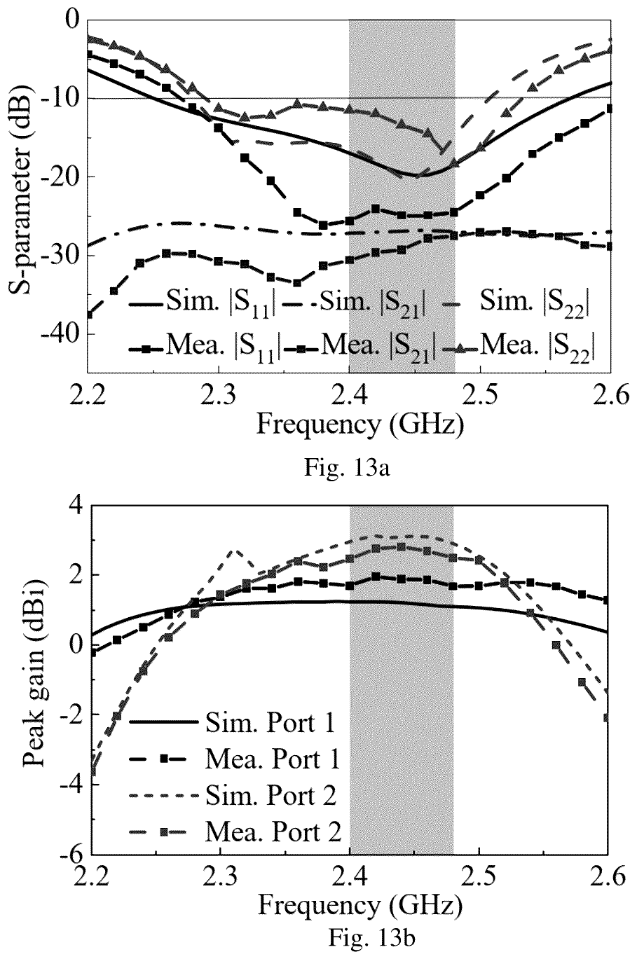

FIG. 13a shows the simulated and measured reflection coefficients of the prototype. From this figure, reasonable agreement between the simulated and measured results is observed. The measured 10-dB impedance bandwidths are 13.5% (2.27-2.60 GHz) and 9.9% (2.29-2.53 GHz) for the VP Port 1 (which corresponds to second port 42 in FIG. 1), and the HP Port 2 (which corresponds to first port 40 in FIG. 1), respectively. Their overlapped bandwidth of 9.9% fully covers the 2.4-GHz Wi-Fi bands. The resonant mode at 2.45 GHz of Port 1 is caused by the DR TM_{01δ} mode, whereas the resonant mode at 2.48 GHz of Port 2 is caused by the DR TE_{01δ+1} mode. The isolation between the two ports is higher than 27 dB in the whole band, indicating that the interference between them is very low.

FIG. 13b shows the simulated and measured antenna peak gains of the prototype. Again, reasonable agreement is observed between the simulated and measured results. It can be seen that the antenna gain is very stable within the 2.4-GHz band, with a variation of less than 0.4 dB. The measured gain is 1.68-1.95 dBi for the VP Port 1, while it is 2.46-2.81 dBi for the HP Port 2. It can be observed that the measured VP gain of Port 1 is slightly higher than the simulated one. This is because the radiation beamwidth of Port 1 is narrowed in the E-plane (ϕ=0°) caused by the stray radiation from the coaxial cable.

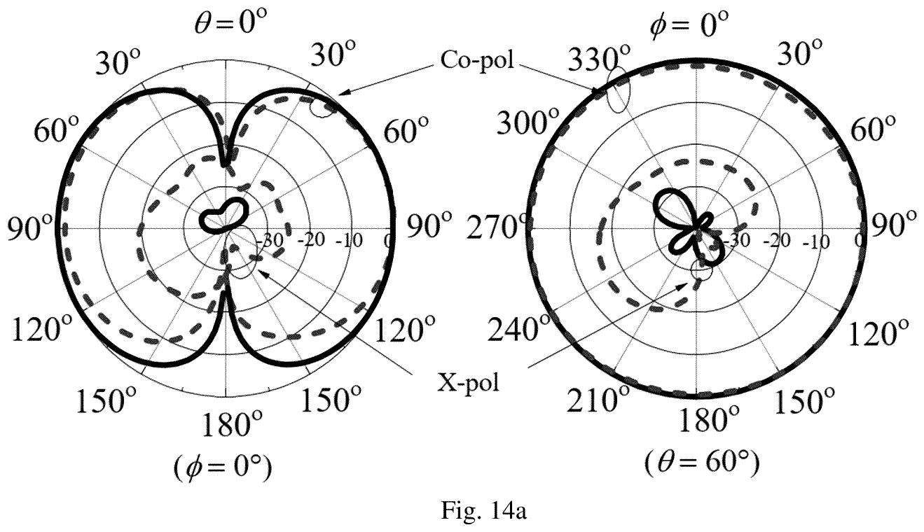

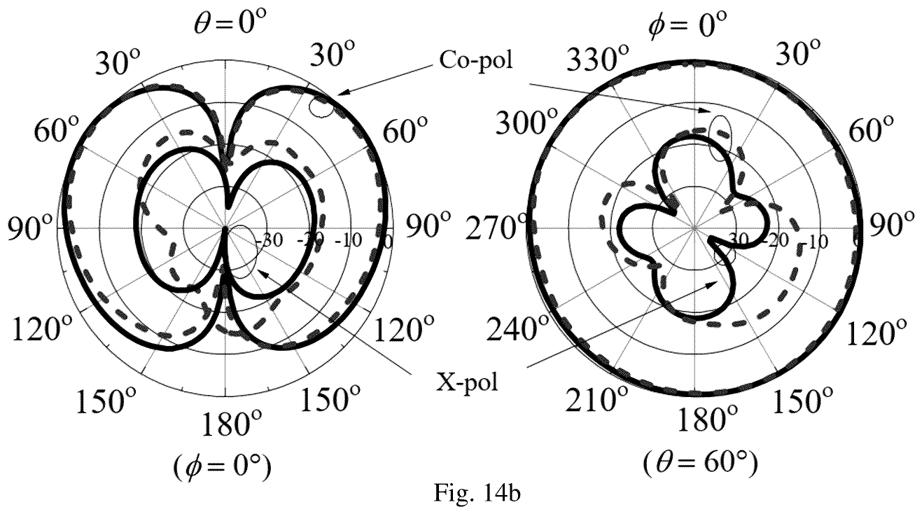

FIGS. 14a-14b show the simulated and measured normalized radiation patterns of the prototype at 2.44 GHz. Both the simulated and measured radiation patterns show a null at 0=0° (z-direction), which is desirable for azimuthal omnidirectional radiation patterns. This is because the equivalent electric dipole (TM_{01δ}) and magnetic dipole (TE_{01δ+1} mode) are along the z-direction. Their radiation is theoretically canceled in this direction. The measured 3-dB beamwidths in the elevation plane (ϕ=0°) are 85° and 61° for Port 1 and Port 2, respectively. They indicate that the glass DRA has a wide coverage. In the azimuthal plane, the co-polarized fields are generally 15 dB stronger than the cross-polarized counterparts. The gain variation in the azimuthal plane is 2.4 dB, indicating uniform radiation and stable signal coverage around the antenna. It was found that the radiation patterns are very stable at other passband frequencies, but the results are not included here for brevity.

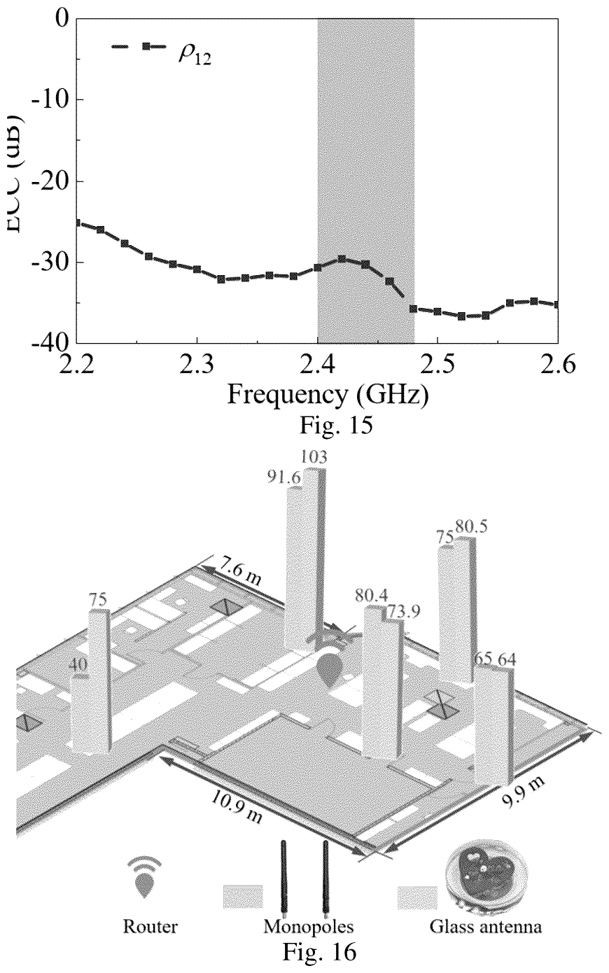

FIG. 15 shows the measured envelope correlation coefficient (ECC) ρₑ, which is a performance index for a multiple-input multiple-output (MIMO) antenna. The measured ECC is obtained from the measured radiation patterns. It can be seen that the ECC is lower than −25 dB in the whole band, which is much lower than the criteria of −3 dB due to the desirable orthogonal polarization.

In order to investigate the performance of our glass antenna in Wi-Fi communication systems, the glass antenna was mounted in a Wi-Fi router as shown in FIG. 12a. Its throughput was measured using IxChariot (Keysight, Inc.). In the measurement, the Wi-Fi router was placed near the center of the lab, while the mobile phone was moved to different locations to comprehensively investigate the throughput performance. In addition, to benchmark the performance of the prototype, a commercial monopole pair with comparable antenna gain was used as reference antenna. It was also mounted on the same Wi-Fi router and placed at the same location. FIG. 16 compares the throughput performance of the reference antenna and the prototype. Each throughput value has averaged five measured data. In other words, each antenna has been tested 25 times. With reference to the figure, the throughput using the prototype is generally higher than that using the conventional monopole pair especially at farther non-line-of-sight positions. It is important that the performance of the glass antenna is not bad at other locations. It was found that on average, using the prototype can increase the throughput by 12%. Also, the prototype has a more stable throughput as compared with the monopole pair. This result is consistent with the bit-error-rate comparison as studied in [43]. In general, it has been found that for Wi-Fi applications, the bit error rate using an omnidirectional polarization-diversity glass antenna is desirably lower than that using a commercial space-diversity monopole antennas [43]. Also, the polarization of the incident wave can be altered by the indoor environment, leading to polarization mismatch with the space-diversity monopole antenna. This problem is avoided by using the omnidirectional polarization-diversity antenna. The glass antenna as shown in FIGS. 1-3 with polarization diversity, has not only a beautiful appearance but also a stable performance, making it an excellent candidate for consumer Wi-Fi applications.

Table I compares the antenna in FIGS. 1-3 (referred as “our antenna” in Table 1) with some reported omnidirectional DRAs. With reference to the table, many designs obtain single polarization only [45]-[49]. Only a few reported designs have dual polarizations [43], [44], [50], [51]. Although dual linear/circular polarizations have been obtained, the feed network requires two substrates [44], [50]. Dual linear polarizations have been realized using a single-layer substrate [43], [51]. However, the feeding method is not planar, so a hole has to be drilled in the dielectric resonator to accommodate the feeding probe. In addition, the useful bandwidth is only 3.3% [51]. In contrast, the antenna of FIGS. 1-3 obtains dual polarizations using a planar feed on a single substrate. Moreover, it has the widest available bandwidth of 9.9% compared to dual-polarized designs.

TABLE I
COMPARISON OF OUR DESIGN WITH REPORTED
OMNIDIRECTIONAL DIELECTRIC RESONATOR
ANTENNAS

| | | | | Layer of |
|---|---|---|---|---|
| Ref. | Bandwidth | Polarization | Planar feed | Substrate |
| [45] | 16.0% (2.4 GHz) | Single VP/HP | Yes | 1 |
| [46] | 28.0% (3.5 GHz) | Single VP | No | — |
| [47] | 8.0% (5.8 GHz) | Single CP | Yes | 1 |
| [48] | 4.5% (2.4 GHz) | Single HP | Yes | 1 |
| [49] | 18.0% (2.4 GHz) | Single VP | Yes | 1 |
| [44] | 7.7% (2.4 GHz) | Dual CP | Yes | 2 |
| [50] | 7.3% (3.8 GHz) | Dual LP | No | 2 |
| [43] | 4.9%, 4.2%, 4.3% | Dual LP | No | 1 |
| | (2.4, 5.2, 5.8 GHz) | | | |
| [51] | 3.3% (2.4 GHz) | Dual LP | No | 1 |
| This | 9.9% (2.4 GHz) | Dual LP | Yes | 1 |
| work | | | | |

CP: Circular polarization,
HP: Horizontal polarization,
VP: Vertical polarization,
LP: linear polarization.

In summary, in the embodiment of FIGS. 1-3 an omnidirectional polarization-diversity glass DRA using planar feeding on a single substrate for consumer Wi-Fi routers is provided. A planar feeding scheme including a circular patch loaded with shorted stubs and an Alford loop has been designed using only a single PCB substrate. It can excite two orthogonal dielectric resonator modes in the same band, providing stable signal coverage. A prototype was fabricated and measured to verify the design. It has been found that the measured available bandwidth is 9.9%, fully covering the 2.4-GHz Wi-Fi bands. The measured isolation is higher than 27 dB within the operating bands. It has been observed that the measured peak antenna gains are 1.68-1.95 dBi and 2.46-2.81 dBi for the VP Port 1 and HP Port 2, respectively. The measured ECC obtained from the radiation fields is lower than −25 dB across the entire band. The prototype of the antenna has been used in place of the conventional space-diversity monopole pair of a commercial Wi-Fi router. It has been observed that our glass antenna has a more stable throughput. In addition, our glass antenna has a more esthetic appearance.

In addition to indoor applications, glass antennas can also be integrated with windows and display screens. It is no doubt that they have potential in other consumer products such as display and automotive electronics.

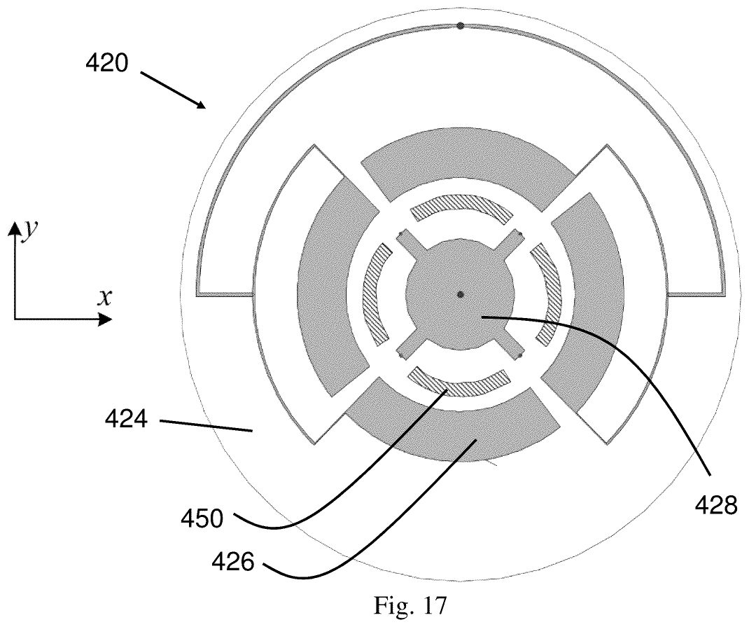

Turning to FIG. 17, which shows the substrate and planar feeding circuit of a polarization-diversity omnidirectional dielectric resonator antenna 420 according to another embodiment of the invention. For the sake of brevity, components, features, and their functions which are similar to those in the antenna of FIGS. 1-3 will not be described in detail again. Rather, only differences between the antenna shown in FIG. 17 as compared to that of FIG. 2 will be described. In the antenna 420 in FIG. 17, the substrate 424 includes four generally identical, generally arc-shaped apertures 450 for enabling passage of light. The four generally arc-shaped apertures 450 are, in plan view, angularly spaced apart and arranged on a generally circular path (not shown, which is generally coaxial with the generally circular path of the electrically conductive strip elements 426 and the center of the electrically conductive patch element 428. More specifically, in plan view, the four generally arc-shaped apertures 450 are arranged in four quadrants, each disposed in a respective area between the electrically conductive patch element 428 and a corresponding one of the electrically conductive strip elements 426.

In this embodiment, a light source (not shown in FIG. 17) for providing light to or through a dielectric resonator (not shown) located on a side of the substrate 424 may be received in the generally arc-shaped apertures 450. The light source may be a light source arranged to provide visible light, such as LEDs. For example, each generally arc-shaped aperture 450 may receive one or more LEDs, which can provide visible light in the same color or in different colors. The light source can provide light to or project light through the dielectric resonator, which in this embodiment is transparent and with picture/pattern arranged in or on it, to project the pattern or picture to outside the antenna 420, and outside any electronic apparatus that incorporates the antenna 420.

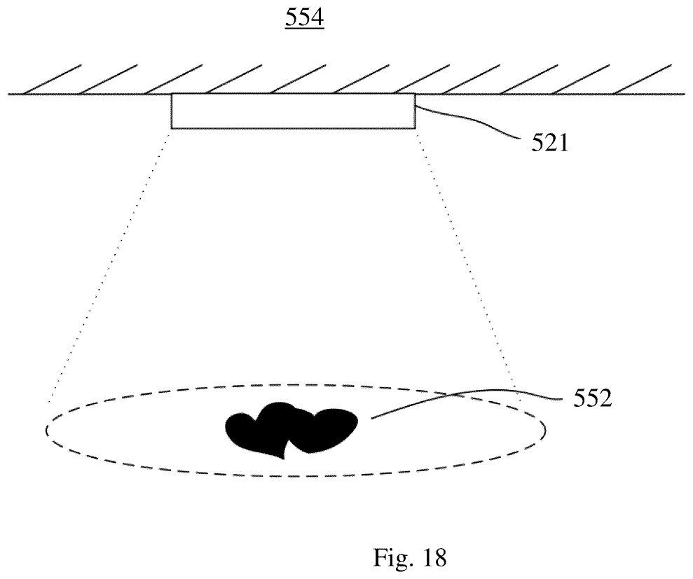

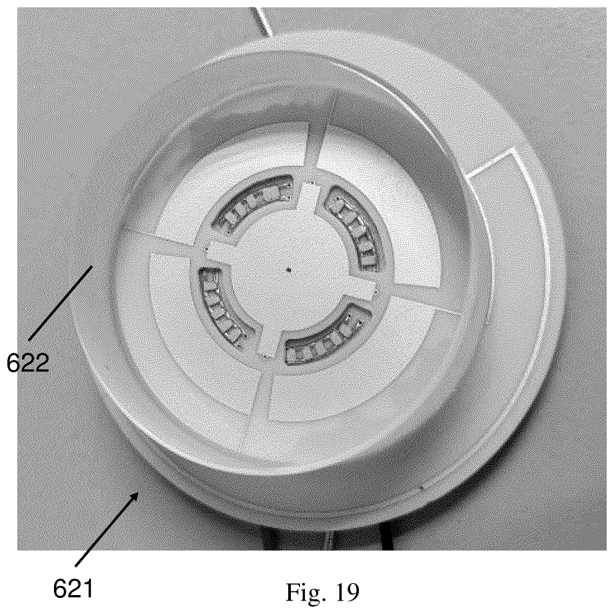

FIG. 18 shows an example installation of such an electronic apparatus 521 of FIG. 1. In this example, the electronic apparatus 521 is mounted to a support structure 554 (e.g., ceiling/wall). The electronic apparatus 521 is operable as an antenna for wireless communication as well as a projector for projecting the picture/pattern arranged in or on the dielectric resonator (not shown in FIG. 18) of the antenna. FIG. 19 shows an example of an electronic apparatus 621 fabricated based on the design of the antenna 420 of FIG. 17, which is arranged for operation at the 2.4 GHz frequency band. For the DRA in the electronic apparatus 621 of FIG. 19, the dielectric resonator block 622 is fabricated with K9 glass (εᵣ=6.85) and the feeding circuits (circular patch, stubs, arch-shaped strips, power divider circuit) are printed on a substrate with a dielectric constant εᵣ of 3.55 and a thickness hₛ of 1.524 mm.

Experiments (simulations and measurements) are performed on the electronic apparatus 621 of FIG. 19. Similar to previous experiment setup, the reflection coefficient is measured using the Agilent 4-port network analyzer E5071C and the radiation pattern and antenna gain are measured using the Satimo Starlab system. The simulated and measured S-parameters, antenna gains, and radiation patterns of the electronic apparatus 621 are similar to those shown in FIGS. 13a-14b for the antenna of FIGS. 1-3, so these results will not be illustrated again. In summary, for the electronic apparatus 621 reasonable agreement is found between the simulated and measured results. The measured −10-dB impedance passband for the VP antenna (port 1) is 2.27 GHz to 2.6 GHz and the measured −10-dB impedance passband for the HP antenna (port 2) is 2.29 GHz to 2.53 GHz. The overlapped bandwidths are 9.95% (2.29 GHz to 2.53 GHz), which cover the 2.4 GHz Wi-Fi band. In this example, the port isolation is higher than 27 dB. The measured VP antenna gains at (#=0°, q=60°) for port 1 is about 1.1 dBi whereas the measured HP antenna gain at (ϕ=0°, q=60°) is about 0.2 dBi. In one experiment, it is found that a higher gain of about 2 dBi can be obtained by increasing the size of the ground plane. In other words, it is determined that the antenna gain can be enhanced by increasing the size of the ground plane.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

Although the exemplary embodiments described above and illustrated in the drawings are each only about a single antenna apparatus, one skilled in the art should realize that embodiments of the invention are also applicable to antenna array/MIMO design.

One will realize that the invention enables a lot of different pictures and/or characters to be projected by the light on a surface. There is literally no limit to the type of pictures or characters, as patterns or pictures can be printed on or etched in the dielectric block. In particular, the dielectric resonator block in different embodiments may have different shapes, sizes, forms, etc. For example, the dielectric resonator block may be shaped as a cylinder, a prism, etc. In some embodiments, the dielectric resonator block may be transparent. In some embodiments, the dielectric resonator block may be made of glass or other transparent material. In some embodiments, pattern and/or picture may be arranged in or on (e.g., printed on or etched in) the dielectric resonator block. In some embodiments, a picture is arranged on the transparent dielectric block and the picture can be projected and enlarged by the light source. In some embodiments, the position of the light source may be adjustable to alter the projection. The parts of the substrate removed to accommodate the light source in different embodiments can have different shapes, sizes, forms, etc. In some example applications, the antenna or antenna apparatus may be mounted to a support structure (e.g., ceiling, wall, table, etc.), and the corresponding projection of the picture/pattern may be on another structure (e.g., the ground, wall, ceiling, etc.), for decoration and/or advertising.

In some embodiments, the antenna apparatus can be integrated with an illumination arrangement (e.g., lights). In some embodiments, the antenna apparatus integrated with illumination arrangement may operate not only as an antenna for wireless communication, but also as a projector for projecting light, patterns, pictures, etc., for decoration and/or advertising.

What is claimed is:

1. A dielectric resonator antenna, comprising:
a) a dielectric resonator; and
b) a substrate on which a planar feeding circuit is configured; the dielectric resonator being located on a first side of the substrate;
wherein the planar feeding circuit comprises a first feeding part and a second feeding part; the first and second feeding parts adapted to excite two orthogonal DRA modes in a same frequency band.

2. The dielectric resonator antenna of claim 1, wherein each of the first feeding part and the second feeding part has a substantially circular or round shape; the first feeding part and the second feeding part being concentrically arranged; the first feeding part located radially outer than the second first feeding part on the substrate.

3. The dielectric resonator antenna of claim 2, wherein the first feeding part is an Alford loop that comprises a plurality of angular strips; between every two adjacent said angular strips there being configured a gap.

4. The dielectric resonator antenna of claim 3, wherein the plurality of angular strips is connected to a 1-4 power divider which is located radially outer than the plurality of angular strips.

5. The dielectric resonator antenna of claim 3, wherein the substrate further comprises a first shorting via at a location of an input of the 1-4 power divider; the first shorting via adapted to connect the power divider to a first feedline.

6. The dielectric resonator antenna of claim 5, wherein the first shorting via is located near a circumference of the substrate.

7. The dielectric resonator antenna of claim 2, wherein the second feeding part comprises a circular patch located at a center of the substrate, and a plurality of shorted stubs extending from the circular patch.

8. The dielectric resonator antenna of claim 6, wherein the plurality of shorted stubs extends from the circular patch along radial directions of the circular patch.

9. The dielectric resonator antenna of claim 3, wherein the second feeding part comprises a circular patch located at a center of the substrate and a plurality of shorted stubs; each said shorted stub extending from the circular patch toward a corresponding one of the gaps.

10. The dielectric resonator antenna of claim 6, wherein the substrate further comprises a second shorting via located at a center of the substrate; the second shorting via adapted to connect the circular patch to a second feedline.

11. The dielectric resonator antenna of claim 1, wherein the dielectric resonator is made of glass.

12. The dielectric resonator antenna of claim 1, wherein the dielectric resonator has a substantially cylindrical shape.

13. The dielectric resonator antenna of claim 1, wherein the dielectric resonator has a dielectric constant greater than that of the substrate.

14. An electronic apparatus, comprising:
a) a body;
b) a lighting device located within or attached to the body;
c) a dielectric resonator antenna of claim 1; the dielectric resonator antenna attached to the body;
wherein the dielectric resonator of the dielectric resonator antenna is made of glass, which is adapted to allow light emitted by the lighting device to pass through the dielectric resonator and be emitted to an outside of the electronic apparatus.

15. The electronic apparatus of claim 14, wherein the substrate of the dielectric resonator is formed with an aperture; the lighting device located on a second side of the substrate opposite to the first side of the substrate; the aperture adapted to allow light emitted by the lighting device to pass through and arrive at the dielectric resonator.
